(19) United States
(12) Patent Application Publication
(10) Pub. No.: US 2026/0275041 A1
(43) Pub. Date: Sep. 17, 2026

(54) CATALYSTS FOR ROOM TEMPERATURE VULCANISABLE (RTV) SILICONE COMPOSITIONS

(71) Applicants: Dow Silicones Corporation, Midland, MI (US); Dow Global Technologies LLC, Midland, MI (US)

(72) Inventors: Jiang Peng, Shanghai (CN); Kai Wang, Shanghai (CN); Xigeng Zhou, Shanghai (CN); Yi Guo, Shanghai (CN); Zhihua Liu, Shanghai (CN); Eric Wang, Shanghai (CN); Ye Wu, Shanghai (CN)

(21) Appl. No.: 19/471,874

(22) PCT Filed: Apr. 27, 2023
(86) PCT No.: PCT/CN2023/091370

§ 371 Date: Oct. 2, 2025

(30) Foreign Application Priority Data
Apr. 27, 2023 (WO) PCT/CN2023/091370

(51) Int. Cl. C08G 77/08; C07F 5/00; C08G 77/16; C08G 77/18; C08K 3/26; C08K 9/04; C09D 7/61; C09D 7/62; C09D 183/06

(52) U.S. Cl. CPC C08G 77/08; C07F 5/003; C08G 77/16; C08G 77/18; C09D 7/61; C09D 7/62; C09D 183/06; C08K 2003/265; C08K 9/04

(57) ABSTRACT

This relates to new cerium (IV) organometallic compounds, to methods for making said cerium (IV) organometallic compounds and to their uses as condensation catalysts e.g., for curing room temperature vulcanisable (RTV) silicone compositions comprising a polyorganosiloxane polymer having at least two hydroxy or hydrolysable groups per molecule, together with a suitable condensation curable cross-linker. Such compositions can include various additives and can be stored in one-part or multiple part compositions. This disclosure also relates to silicone elastomers and cured silicone sealants and/or adhesives prepared by curing said compositions using the cerium (IV) organometallic compounds as the catalysts.

This relates to new cerium (IV) organometallic compounds, to methods for making said cerium (IV) organometallic compounds and to their uses as condensation catalysts e.g., for curing room temperature vulcanisable (RTV) silicone compositions comprising a polyorganosiloxane polymer having at least two hydroxy or hydrolysable groups per molecule, together with a suitable condensation curable cross-linker. Such compositions can include various additives and can be stored in one-part or multiple part compositions. This disclosure also relates to silicone elastomers and cured silicone sealants and/or adhesives prepared by curing said compositions using the cerium (IV) organometallic compounds as the catalysts.

For many years, condensation curable silicone sealants have mainly relied upon titanate and/or zirconate-based catalysts and/or tin (II) and tin (IV) based catalysts. It is well known to those skilled in the art that alkoxy titanium compounds, i.e., alkyl titanates, are suitable catalysts for one component moisture curable silicone compositions. Titanate catalysts have been widely described for their use to formulate skin or diffusion cured one-part condensation curing silicone elastomers. These formulations are typically available in one-part packages that are applied in a layer that is thinner than 15 mm in depth. Layers of such sealants applied in an amount thicker than 15 mm in depth are known to lead to uncured sealant in the depth of the material, because the moisture relied upon to cure such materials tends to be very slow to diffuse in very deep sections. Skin or diffusion cure (e.g., moisture/condensation) takes place when the initial cure process takes place by the formation of a cured skin at the composition/air interface subsequent to the sealant/adhesive being applied on to a substrate surface. Subsequent to the generation of the surface skin the cure speed is dependent on the speed of diffusion of moisture from the sealant/adhesive interface with air to the inside (or core), and the diffusion of condensation reaction by-product/effluent from the inside (or core) to the outside (or surface) of the material and the gradual thickening of the cured skin over time from the outside/surface to the inside/core.

Whilst such condensation curable compositions are widely used in the industry, it is known that in some problems remain. For example, titanate and/or zirconate catalysed sealants are known to discolour or undergo yellowing after sealant aging for a long time. Furthermore, it is known that adhesion failure of sealants which relied upon titanate and/or zirconate-based catalysts as curatives may occur due to degradation under UV.

Tin (II) and tin (IV) based catalysts can be used in some one-part sealant packages but are usually utilised as catalysts in multi-part room temperature vulcanisable (RTV) silicone compositions. Multi-part compositions designed to activate condensation cure in the bulk of the product (bulk cure), In silicone compositions stored before use in two or more parts, one part usually contains a filler which typically contains the moisture required to activate condensation cure in the bulk of the product. Unlike the previously mentioned diffusion cure one-part system, two-part condensation cure systems, once mixed together, enable bulk cure even in sections greater than 15 mm in depth. In this case the composition will cure (subsequent to mixing) throughout the material bulk. If a skin is formed, it will be only in the first minutes after application. Soon after, the product will become a solid in the entire mass.

Until recently, titanate catalysts i.e., tetra alkyl titanates (e.g., Ti(OR′)₄ where R′ is an alkyl group having at least one carbon) and chelated titanates were not used for curing two part condensation curable compositions because it was well known that they are sensitive to hydrolysis (e.g., the cleavage of bonds in functional groups by reaction with water) or alcoholysis in presence of water or alcohol respectively. Unfortunately, titanium compounds of this type quickly react and liberate the corresponding alcoholic groups bound to the titanium. For example, in the presence of moisture, tetra alkyl titanate catalysts can fully hydrolyse to form titanium (IV) hydroxide (Ti(OH)₄), which is of only limited solubility in silicone-based compositions. Crucially, the formation of titanium hydroxides such as titanium (IV) hydroxide can dramatically negatively affect their catalytic efficiency towards curing condensation curable silicone compositions, leading to uncured or at best only partially cured systems.

This issue is not seen with tin (IV) catalysts because they are not similarly affected by e.g., water contained in the filler present in one of the parts of the product, resulting in the historic understanding that such two-part condensation curable compositions require tin catalysts. However, compositions and sealants relying on tin-based catalysts may undergo reversion.

Reversion may be identified pre-cure and post-cure. In the case of pre-cure reversion, the sealant composition is destabilization in the presence of tin-based catalysts whereby the sealant composition undergoes a significant decrease in viscosity during storage due to scission of the polymer molecules. Post-cure reversion is also a well-known issue in tin-based catalyst compositions whereby elastomers produced by tin cured systems as described herein, if heated immediately or shortly after having been cured undergo reversion. Post-cure reversion is also a well-known issue in silicone sealant compositions which are cured with the assistance of tin-based catalysts (tin cured compositions) whereby elastomers produced from tin cured compositions as described herein, if heated immediately or shortly after having been cured undergo reversion. During this heating period, the elastomers liquefy or soften internally, although most of the time they remain solid on their external surfaces; nevertheless, the relatively thin layer which remains under these conditions is frequently sticky. This “reversion” can be produced at temperatures above 80° C. However, in the majority of cases it is produced at temperatures above 100° C. and it is particularly marked when the elastomers are heated in the total or virtual absence of air, which is to say, when the heated elastomers are in a partly or wholly closed system when being heated.

Furthermore, due to recent legislation, tin-based catalysts, which are used in many condensation reaction curable polyorganosiloxane products such as sealants and coatings, are to be phased out.

Hence, there is an industry wide desire to find alternative suitable compounds which can be utilised as cure catalysts for curing room temperature vulcanisable (RTV) silicone compositions.

There is provided herein a cerium (IV) organometallic compound of the formula:

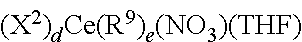

where X² is a bidentate ligand formed from any suitable 1,2-dicarbonyl compound, 1,3-dicarbonyl compound or 1,4-dicarbonyl compound; THF is tetrahydrofuran;
R⁹ is an alkoxy group having from 1 to 10 carbons or a carboxylate group having from 1 to 20 carbons; and
d and e are one or two with the proviso that d+e=3.

There is also provided herein a method of making a cerium (IV) organometallic compound of the formula:

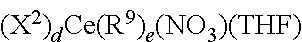

where X² is a bidentate ligand formed from any suitable 1,2-dicarbonyl compound, 1,3-dicarbonyl compound or 1,4-dicarbonyl compound;
THF is tetrahydrofuran;
R⁹ is an alkoxy group having from 1 to 10 carbons or a carboxylate group having from 1 to 20 carbons; and
d and e are one or two with the proviso that d+e=3; by
   (i) Dissolving an amount of Ce(R⁹)₃(NO₃)(THF)₂ in toluene to form a clear solution, optionally a saturated solution with a little solid left in the mixture to form a step (i) product;
   (ii) sealing the product of step (i) in a chemically unreactive atmosphere;
   (iii) Introducing one or two molar equivalents of the bidentate ligand relative to the KCe₂(R⁹)₉(THF)₂ while agitating to form the cerium (IV) organometallic compound.

Preferably, the step (i) product is isolated and purified before step (iii), usually at the end of step (i) before step (ii).

There is provided herein a cerium (IV) organometallic compound obtained or obtainable by
(i) Dissolving an amount of Ce(R⁹)₃(NO₃)(THF)₂ in toluene to form a clear solution, optionally a saturated solution with a little solid left in the mixture to form a step (i) product;
(ii) sealing the product of step (i) in a chemically unreactive atmosphere;
(iii) Introducing one or two molar equivalents of the bidentate ligand relative to the KCe₂(R⁹)₉(THF)₂, while agitating to form the cerium (IV) organometallic compound.

Preferably, the step (i) product is isolated and purified before step (iii), usually at the end of step (i) before step (ii).

There is also provided herein a use of a cerium (IV) organometallic compound of the formula:

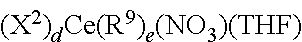

where X² is a bidentate ligand formed from any suitable 1,2-dicarbonyl compound, 1,3-dicarbonyl compound or 1,4-dicarbonyl compound;
THF is tetrahydrofuran;
R⁹ is an alkoxy group having from 1 to 10 carbons or a carboxylate group having from 1 to 20 carbons; and
d and e are one or two with the proviso that d+e=3; in or as a condensation reaction catalyst.

There is provided herein a condensation curable room temperature vulcanisable (RTV) silicone composition comprising:
(a) an organopolysiloxane polymer having at least two hydroxyl or hydrolysable groups per molecule;
(b) one or more cross-linkers in the form of a silicon containing compound having at least two, alternatively at least three hydrolysable groups per molecule; and
(c) one or more catalysts comprising the cerium (IV) organometallic compound as hereinbefore described.

In one embodiment, the above condensation curable room temperature vulcanisable (RTV) silicone composition component (a) may comprise:
(a) an organopolysiloxane polymer having at least two hydroxyl or hydrolysable groups per molecule of the formula

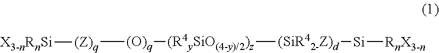

in which each X is independently a hydroxyl group or a hydrolysable group, each R is an alkyl, alkenyl or aryl group, each R⁴ is an X group, alkyl group, alkenyl group or aryl group and Z is a linear or branched alkylene group having from 1 to 12 carbon atoms which may be interrupted by one or more linear or branched siloxane groups comprising from 1 to 20 silicon atoms; d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 150,000 mPa·s at 25° C., alternatively from 40,000 to 140,000 mPa·s at 25° C.

There is also provided a use of the aforementioned composition upon cure as a sealant in the facade, insulated glass, window construction, automotive, solar and construction fields.

There is also provided a method for filling a space between two substrates so as to create a seal therebetween, comprising:
a) providing a silicone composition as hereinbefore described, and either
b) applying the silicone composition to a first substrate, and bringing a second substrate in contact with the silicone composition that has been applied to the first substrate, or
c) filling a space formed by the arrangement of a first substrate and a second substrate with the silicone composition and
d) curing the silicone composition.

The concept of “comprising” where used herein is used in its widest sense to mean and to encompass the notions of “include” and “consist of”.

For the purpose of this application “substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

In the present disclosure the cerium (IV) organometallic compound disclosed has the formula:

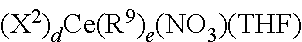

where X² is a bidentate ligand formed from any suitable 1,2-dicarbonyl compound, 1,3-dicarbonyl compound or 1,4-dicarbonyl compound which act as chelating agents;
THF is tetrahydrofuran;
R⁹ is an alkoxy group having from 1 to 10 carbons or a carboxylate group having from 1 to 20 carbons; and
d and e are 1 or 2 with the proviso that d+e=3.
R⁹ is an alkoxy group having from 1 to 10 carbons or a carboxylate group having from 1 to 20 carbons. Each R⁹ may be the same or different, alternatively each R⁹ is the same.

When R⁹ is an alkoxy group having from 1 to 10 carbons it may be a primary, secondary or tertiary alkoxy group which may be linear or branched containing from 1 to 10 carbons. Examples may include but are not restricted to methoxy, ethoxy, propoxy, isopropoxy, n-butoxy, tertiary butoxy, pentoxy, tertiary pentoxy or hexoxy or a branched secondary alkoxy group such as 2,4-dimethyl-3-pentoxy. Alternatively, when R⁹ is an alkoxy group, the alkoxy group may have from 3 to 10 alkoxy groups, for example isopropoxy, n-butoxy, tertiary butoxy, pentoxy, tertiary pentoxy or hexoxy or a branched secondary alkyl group such as 2,4-dimethyl-3-pentoxy.

When R⁹ is a carboxylate group having from 1 to 20 carbons, it may be a primary, secondary or tertiary carboxylate group which may be linear or branched and aliphatic or aromatic containing from 1 to 20 carbons. Examples may include but are not restricted to a propanoate (propionate) group (CH₃CH₂C(═O)—O—), an acetate group (CH₃C(═O)—O—), a butanoate group (CH₃(CH₂)₂C(═O)—O—), a 2-methyl propanoate (isobutyrate) group ((CH₃)₂CHC(═O)—O—), a benzoate group (C₆H₅—C(═O)—O—), a 2-ethylhexanoate group (CH₃(CH₂)₃CH(C₂H₅)C(═O)—O—), a stearate group (CH₃(CH₂)₁₆C(═O)—O—), a 2-ethylbutanoate (diethylacetate) group (C₂H₅)₂CHC(═O)—O—) or a naphthenate group.

The bidentate ligand X² is formed from any suitable 1,2-dicarbonyl compound, 1,3-dicarbonyl compound or 1,4-dicarbonyl compound, which act as chelating agents. Bidentate ligand X² may for example be a compound of the general formula:

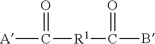

In which
R¹ is an optionally substituted alkylene radical having from 1 to 4 carbon atoms,
A′ is selected from the group consisting of:
(!) —(CX¹₂)ₙC(R²)₃ wherein n is from 0 to 5,
(!!) an adamantyl group and
(!!!) an adamantyl derivative;
B′ is selected from the group consisting of:
a″) —(CX¹₂)ₜC(R²)₃, wherein t has a value of from 0 to 5,
b″) a monovalent alkyl group having from 1 to 10 carbon atoms, and
c″) OR³, wherein R³ is selected from (a″) or (b″)
each X¹ is the same or different and is a halogen group or hydrogen;
each R² is the same or different and is X¹ or an alkyl radical having one to eight carbon atoms.

When present, the/or each X¹ may be a halogen radical. Most preferably the halogen radical is a fluorine radical. Similarly, it is preferred that the/or each R² group is a halogen radical and most preferably it is a fluorine radical. Alternatively, the/or each R² group is an alkyl group, most preferably a methyl or ethyl, tertiary butyl or n-butyl group. In a most preferred formulation n is zero.

R¹ is most preferably a methylene group but can have one alkyl or halogen substituted alkyl group with 1 to 5 carbon atoms.

The adamantyl group is a derivative of adamantane or tricyclo-3,3,1,1-decane which is a rigid ring system based on three fused cyclohexane rings.

Examples of the compounds which are provided to form bidentate ligand X² include but are not limited to a 1,2-dicarbonyl, 1,3-dicarbonyl or 1,4-dicarbonyl, typically a 1,2-diketone, 1,3-diketone, or a 1,4-diketone. Specific examples of the bidentate ligand X² include β-diketones: 1,1,1-Trifluoro-2,4-pentanedione, 2,4-pentanedione (acac); 2,4-hexanedione; 2,4-heptanedione; 3,5-heptanedione: 3-ethyl-2,4-pentanedione; 5-methyl-2,4-hexanedione; 2,4-octanedione; 3,5-octanedione; 5,5-dim-ethyl-2,4-hexanedione; 6-methyl-2,4-heptanedione; 2,2-dimethyl-3,5-nonanedione; 2,6-dimethyl-3,5-heptanedione; 2-acetylcyclohexanone (Cy-acac); 2,2,6,6-tetramethyl-3,5-heptanedione (t-Bu-acac); 1,1,1,5,5,5-hexafluoro-2,4-pen-tanedione (F-acac)]; benzoylacetone; dibenzoylmethane; 3-methyl-2,4-pentadione; 3-acetyl-2-pentanone; 3-acetyl-2-hexanone; 3-acetyl-2-heptanone; 3-acetyl-5-methyl-2-hexanone; stearoyl benzoyl methane; octanoyl benzoyl methane; 4-t-butyl-4′-methoxydibenzoylmethane; 4,4′-dimethoxy-dibenzoylmethane and 4,4′-di-tart-butyldibenzoylmethane, methyl pivaloylacetate (MPA), Ethyl 4,4,4-trifluoroacetoacetate (TFEAA) or 1,1,1-Trifluoro-2,4-pentanedione (TFAA), ethyltrifluoromethylacetoacetate, methylpentafluoroethylacetoacetate, ethylpentafluoroethylacetoacetate, ethyl-2-ethylacetoacetate, acetoacetate and ethyl acetoacetate.

The cerium (IV) organometallic compound described herein may be prepared by any suitable method. In one embodiment, a method of making the cerium (IV) organometallic compound described above may be undertaken by
(i) Dissolving an amount of Ce(R⁹)₃(NO₃)(THF)₂ in toluene to form a clear solution, optionally a saturated solution with a little solid left in the mixture to form a step (i) product;
(ii) sealing the product of step (i) in a chemically unreactive atmosphere;
(iii) Introducing 1 or 2 molar equivalents of the bidentate ligand relative to the KCe₂(R⁹)₉(THF)₂ by any suitable means e.g., through a syringe, while agitating to form the cerium (IV) organometallic compound.

Any suitable unreactive gas may be utilised to form the chemically unreactive atmosphere of step (ii), for example nitrogen and/or a noble gas such as argon.

Agitation used during step (iii) may take any suitable form. It may be swirled, shaken or sonically agitated or the like. It was found that a distinct colour change occurred very quickly after the bidentate ligand was introduced in step (iii).

It was found that:
(i) when one molar equivalent of the bidentate ligand was introduced during step (ii) relative to the Ce(R⁹)₃(NO₃)(THF)₂, substantially, if not completely d was 1 and e was 2 in the resulting (X²)_{d}Ce(R⁹)ₑ(NO₃)(THF) product; and
(ii) when two molar equivalents of the bidentate ligand were introduced during step (ii) relative to the Ce(R⁹)₃(NO₃)(THF)₂, substantially, if not completely d was 2 and e was 1 in the resulting (X²)_{d}Ce(R⁹)ₑ(NO₃)(THF) product.

Such a process is depicted pictorially below wherein each R⁹ was a tertiary butyl (^{t}bu) group and the bidentate ligand was trifluoroacetoacetate which is referred to herein as TFEAA.

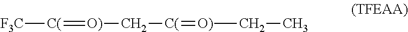

Firstly, when one molar equivalent of FEAA was introduced and (TFEAA)Ce(O^{t}Bu)₂(NO₃)(THF) produced.

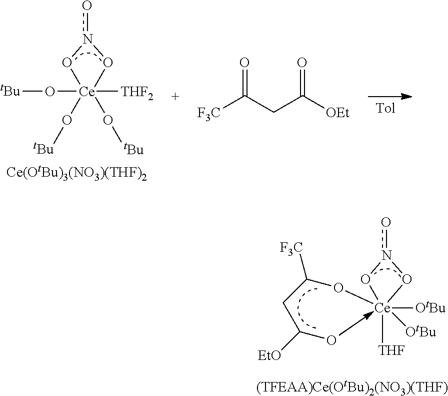

And secondly when two molar equivalents were introduced (TFEAA)₂Ce(O^{t}Bu)(NO₃)(THF) was produced.

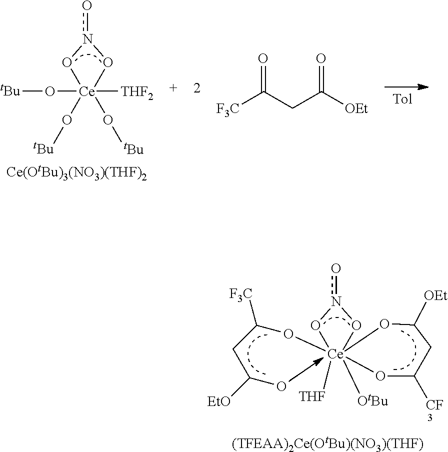

The cerium (IV) starting material for the above reactions (Ce(R⁹)₃(NO₃)(THF)₂) is produced by reacting ammonium cerium (IV) nitrate (NH₄)₂Ce(NO₃)₆ with four molar equivalents of a potassium alkoxide or sodium alkoxide in tetrahydrofuran (THF). The alkoxide group conforming to (R⁹) above. Hence, in the examples above the alkoxide is a tertiary butoxide (O^{t}bu) and the resulting product was Ce(O^{t}Bu)₃(NO₃)(THF)₂.

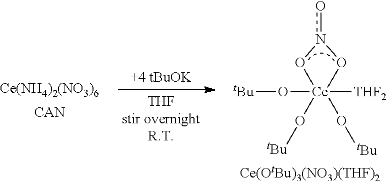

The cerium (IV) organometallic compounds described herein have been found to be suitable for use in or as condensation reaction catalysts.

In one embodiment cerium (IV) organometallic compounds described herein may be used as the catalyst in a condensation curable room temperature vulcanisable (RTV) silicone composition. For example, cerium (IV) organometallic compounds as described herein may be used in condensation curable room temperature vulcanisable (RTV) silicone compositions comprising:
(a) an organopolysiloxane polymer having at least two hydroxyl or hydrolysable groups per molecule;
(b) one or more cross-linkers in the form of a silicon containing compound having at least two, alternatively at least three hydrolysable groups per molecule; and
(c) one or more catalysts comprising the cerium (IV) organometallic compound as hereinbefore described.

In such a composition component (a) may comprise
(a) an organopolysiloxane polymer having at least two hydroxyl or hydrolysable groups per molecule of the formula

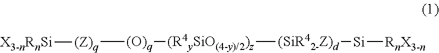

in which each X is independently a hydroxyl group or a hydrolysable group, each R is an alkyl, alkenyl or aryl group, each R⁴ is an X group, alkyl group, alkenyl group or aryl group and Z is a linear or branched alkylene group having from 1 to 12 carbon atoms which may be interrupted by one or more linear or branched siloxane groups comprising from 1 to 20 silicon atoms;
d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 150,000 mPa·s at 25° C., alternatively from 40,000 to 140,000 mPa·s at 25° C.

As previously mentioned, there is also provided herein a condensation curable room temperature vulcanisable (RTV) silicone composition comprising:
(a) an organopolysiloxane polymer having at least two hydroxyl or hydrolysable groups per molecule;
(b) one or more cross-linkers in the form of a silicon containing compound having at least two, alternatively at least three hydrolysable groups per molecule; and
(c) one or more catalysts comprising the cerium (IV) organometallic compound as hereinbefore described.

In such a condensation curable room temperature vulcanisable (RTV) silicone composition component (a) may comprise
(a) an organopolysiloxane polymer having at least two hydroxyl or hydrolysable groups per molecule of the formula

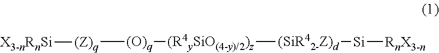

in which each X is independently a hydroxyl group or a hydrolysable group, each R is an alkyl, alkenyl or aryl group, each R⁴ is an X group, alkyl group, alkenyl group or aryl group and Z is a linear or branched alkylene group having from 1 to 12 carbon atoms which may be interrupted by one or more linear or branched siloxane groups comprising from 1 to 20 silicon atoms;
d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 150,000 mPa·s at 25° C., alternatively from 40,000 to 140,000 mPa·s at 25° C.

### Organopolysiloxane Polymer (a)

Organopolysiloxane polymer (a) of such a condensation curable room temperature vulcanisable (RTV) silicone composition may be any suitable organopolysiloxane polymer having at least two hydroxyl or hydrolysable groups per molecule which is able to undergo RTV cure with cross-linker (b) in the presence a cerium (IV) catalyst as hereinbefore described.

In particular organopolysiloxane polymer (a) may have the formula

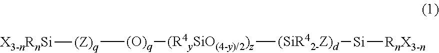

in which case, each X is independently a hydroxyl group or a hydrolysable group, each R is an alkyl, alkenyl or aryl group, each R⁴ is an X group, alkyl group, alkenyl group or aryl group and Z is a divalent organic group;
d is 0 or 1, q is 0 or 1 and d+q=1; n is 0, 1, 2 or 3, y is 0, 1 or 2, and z is an integer such that said organopolysiloxane polymer (a) has a viscosity of from 30,000 to 150,000 mPa·s at 25° C., alternatively from 40,000 to 140,000 mPa·s at 25° C., in accordance with Corporate test method CTM 0050, which is publicly available, and which is based on ASTM D 1084-16 method B, using a Brookfield HBDV-III Ultra Rheometer equipped with a cone-and-plate geometry using spindle 52. All viscosity measurements herein are taken at 25° C. unless otherwise indicated. Alternatively, the viscosity may be measured using a Modular Compact Rheometer (MCR) 302 rheometer from Anton Paar GmbH of Graz, Austria with the most suitable settings and plates for the viscosity concerned. For example, viscosities in the range of 30,000-160,000 mPa·s may be measured using the MCR 302 rheometer with a 40 mm diameter cone-plate and a shear rate of 1 s⁻¹; viscosities in the range 2000-30,000 mPa·s may be measured using the MCR 302 rheometer with a 50 mm diameter cone-plate and a shear rate of 1 s⁻¹; and viscosities in the range 10-2000 mPa·s may be measured using the MCR 302 rheometer with a 75 mm diameter cone-plate and a shear rate of 1 s⁻¹.

When organopolysiloxane polymer (a) has the above formula, each X group of organopolysiloxane polymer (a) may be the same or different and can be a hydroxyl group or a condensable or hydrolyzable group. The term “hydrolyzable group” means any group attached to the silicon which is hydrolyzed by water at room temperature. The hydrolyzable group X includes groups of the formula —OT, where T is an alkyl group such as methyl, ethyl, isopropyl, octadecyl, an alkenyl group such as allyl, hexenyl, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH₃.

When organopolysiloxane polymer (a) has the above formula, the most preferred X groups are hydroxyl groups or alkoxy groups. Illustrative alkoxy groups are methoxy, ethoxy, propoxy, isopropoxy, n-butoxy, t-butoxy, isobutoxy, pentoxy, hexoxy octadecyloxy and 2-ethylhexoxy; dialkoxy groups, such as methoxymethoxy or ethoxymethoxy and alkoxyaryloxy, such as ethoxyphenoxy groups. The most preferred alkoxy groups are methoxy or ethoxy groups. When d=1, n is typically 0 or 1 and each X is an alkoxy group, alternatively an alkoxy group having from 1 to 3 carbons, alternatively a methoxy or ethoxy group.

In such a case when organopolysiloxane polymer (a) has the following structure: X₃₋ₙRₙSi—(Z)—(R⁴_{y}SiO_{(4-y)/2})_{z}—(SiR⁴₂·Z)—Si—RₙX₃₋ₙ with R, R⁴, Z, y and z being the same as previously identified above, n being 0 or 1 and each X being an alkoxy group. Each R is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to 10 carbon atoms, alternatively from 2 to 6 carbon atoms such as vinyl, allyl and hexenyl groups; aromatic groups, alternatively aromatic groups having from 6 to 20 carbon atoms, substituted aliphatic organic groups such as 3,3,3-trifluoropropyl groups aminoalkyl groups, polyaminoalkyl groups, and/or epoxyalkyl groups.

Each R⁴ is individually selected from the group consisting of X or R with the proviso that cumulatively at least two X groups and/or R⁴ groups per molecule are hydroxyl or hydrolysable groups. It is possible that some R⁴ groups may be siloxane branches off the polymer backbone which branches may have terminal groups as hereinbefore described. Most preferred R⁴ is methyl. Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene group may for example be individually selected from an ethylene, propylene, butylene, pentylene and/or hexylene group.

Additionally, n is 0, 1, 2 or 3, d is 0 or 1, q is 0 or 1 and d+q=1. In one alternatively when q is 1, n is 1 or 2 and each X is an OH group or an alkoxy group. In another alternative when d is 1 n is 0 or 1 and each X is an alkoxy group.

Organopolysiloxane polymer (a) has a viscosity of from 30,000 to 150,000 mPa·s at 25° C., alternatively from 40,000 to 140,000 mPa·s at 25° C. with the viscosities determined using one of the methods as described above; z is therefore an integer enabling such a viscosity, alternatively z is an integer from 300 to 5000. Whilst y is 0, 1 or 2, substantially y=2, e.g., at least 90%, alternatively 95% of R⁴_{y}SiO_{(4-y)/2} groups are characterized with y=2.

When desired, organopolysiloxane polymer (a) can be a single siloxane represented by Formula (1) or it can be mixtures of organopolysiloxane polymers represented by the aforesaid formula. Hence, the term any individual organopolysiloxane polymer (a) or mixtures of organopolysiloxane polymer (a).

The Degree of Polymerization (DP), (i.e., in the above formula substantially z), is usually defined as the number of monomeric units in a macromolecule or polymer or oligomer molecule of silicone.

Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by gel permeation chromatography (GPC) with precision of about 10-15% using polystyrene standards.

This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity. In the present disclosure the number average molecular weight and weight average molecular weight values of component (a) herein may, for example, be determined using a Waters 2695 Separations Module equipped with a vacuum degasser, and a Waters 2414 refractive index detector (Waters Corporation of MA, USA). The analyses may then be performed using certified grade toluene flowing at 1.0 mL/min as the eluent. Data collection and analyses may be performed using Waters Empower GPC software.

The different components and any additives present in compositions exemplified herein are defined in parts by weight relative to 100 parts by weight of organopolysiloxane polymer (a) in the present disclosure and not in wt. % and therefore the total of parts by weight will always be greater than 100 parts by weight.

### Component (b)

Condensation curable room temperature vulcanisable (RTV) silicone compositions descried herein and catalysed using the cerium (IV) organometallic compounds defined above may comprise a component (b) which is one or more cross-linkers comprising a silicon containing compound having at least two alternatively at least three hydroxyl and/or hydrolysable groups per molecule. In such compositions, component (b) is effectively functioning as a cross-linker and as such requires a minimum of 2 hydrolysable groups per molecule and preferably 3 or more. Component (b) may have two hydrolysable groups when component (a) has three or more hydroxyl or hydrolysable groups per molecule. Component (b) may thus have two but alternatively has three or more silicon-bonded condensable (preferably hydroxyl and/or hydrolysable) groups per molecule which are reactive with the silanol groups and/or alkoxy groups in component (a).

Typically, component (b) of such condensation curable room temperature vulcanisable (RTV) silicone compositions cured using the cerium (IV) organometallic compounds as catalysts may comprise
one or more silanes having at least 2 hydrolysable groups, alternatively at least 3 hydrolysable groups per molecule group; and/or
one or more silyl functional molecules having at least 2 silyl groups, each silyl group containing at least one hydrolysable group.

For the sake of the disclosure herein a disilyl functional molecule comprises two silicon atoms each having at least one hydrolysable group, where the silicon atoms are separated by an organic chain or a siloxane chain not described above. Typically, each silyl groups on the disilyl functional molecule may be terminal groups. The spacer may be a polymeric chain.

The hydrolysable groups on the silyl groups may be selected from acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and alkenyloxy groups (for example isopropenyloxy and 1-ethyl-2-methylvinyloxy). In some instances, the hydrolysable group may include hydroxyl groups. Alternatively, said hydrolysable groups on the silyl groups are selected from acyloxy groups; alkoxy groups and/alkenyloxy groups.

When component (b) is a silane, said silanes may include alkoxy functional silanes, oximosilanes, acetoxy silanes, acetonoxime silanes and/or enoxy silanes. Preferably when component (b) is a silane, said silanes may include alkoxy functional silanes, acetoxy silanes, acetonoxime silanes and/or enoxy silanes with alkoxy functional silanes most preferred.

When component (b) is a silane and when the silane has only three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. The fourth silicon-bonded organic groups may be methyl.

A typical silane may be described by formula (8)

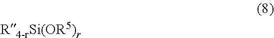

wherein each R⁵ may be the same or different and is hydrogen or an alkyl group containing at least one carbons, alternatively from 1 to 20 carbons, alternatively from 1 to 10 carbons alternatively from 1 to 6 carbons, and r has a value of 2, 3 or 4. Typical silanes are those wherein R″ represents methyl, ethyl or vinyl or isobutyl. R″ is an organic radical selected from linear and branched alkyls, allyls, phenyl and substituted phenyls, acetoxy, oxime. In some instances, R⁵ represents methyl or ethyl and r is 3.

Another type of suitable silanes for component (b) are molecules of the formula Si(OR⁵)₄ where R⁵ is as described above, alternatively, propyl, ethyl or methyl. Partial condensates of Si(OR⁵)₄ may also be considered.

In a further embodiment component (b) is a silyl functional molecule having at least 2 silyl groups each having at least 1 and up to 3 hydrolysable groups, alternatively each silyl group has at least 2 hydrolysable groups.

Component (b) may be a disilyl functional polymer, that is, a polymer containing two silyl groups, each containing at least one hydrolysable group such as described by the formula (4)

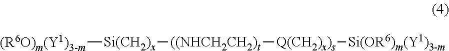

where R⁶ is a C₁₋₁₀ alkyl group, Y¹ is an alkyl groups containing from 1 to 8 carbons,
Q is a chemical group containing a heteroatom with a lone pair of electrons e.g., an amine, N-alkylamine or urea; each x is an integer of from 1 to 6, t is 0 or 1; each m is independently 1, 2 or 3 and s is 0 or 1.

When component (b) is a disilyl functional polymer, the polymer may have an organic polymeric backbone. The polymeric backbone of a silyl (e.g., disilyl) functional component (b) may be organic, i.e., component (b) may comprise organic based polymers with silyl terminal groups e.g., silyl polyethers, silyl acrylates and silyl terminated polyisobutylenes. In the case of silyl polyethers the polymer chain is based on polyoxyalkylene based units. Such polyoxyalkylene units preferably comprise a linear predominantly oxyalkylene polymer comprised of recurring oxyalkylene units, (—CₙH₂ₙ—O—) illustrated by the average formula (—CₙH₂ₙ—O—) y wherein n is an integer from 2 to 4 inclusive and y is an integer of at least four. Likewise, the viscosity will be ≤1000 at 25° C. mPa·s, alternatively 250 to 1000 mPa·s at 25° C. alternatively 250 to 750 mPa·s at 25° C. and will have a suitable number average molecular weight of each polyoxyalkylene polymer block present. The viscosity may be measured using any suitable means e.g., a Modular Compact Rheometer (MCR) 302 from Anton Paar GmbH of Graz, Austria using the most suitable settings and plates for the viscosity concerned as described above. Moreover, the oxyalkylene units are not necessarily identical throughout the polyoxyalkylene monomer but can differ from unit to unit. A polyoxyalkylene block or polymer, for example, can be comprised of oxyethylene units, (—C₂H₄—O—); oxypropylene units (—C₃H₆—O—); or oxybutylene units, (—C₄H₈—O—); or mixtures thereof.

Other polyoxyalkylene units may include for example: units of the structure:

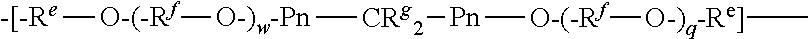

in which Pn is a 1,4-phenylene group, each R^{e} is the same or different and is a divalent hydrocarbon group having 2 to 8 carbon atoms, each R^{f} is the same or different and, is, an ethylene group or propylene group, each R^{e} is the same or different and is, a hydrogen atom or methyl group and each of the subscripts w and q is a positive integer in the range from 3 to 30.

For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

In the case of such organic based cross-linkers the molecular structure can be straight chained, branched, cyclic or macromolecular, i.e., an organic polymer chain bearing alkoxy functional end groups.

Whilst any suitable hydrolysable groups may be utilised, it is preferred that the hydrolysable groups are alkoxy groups and as such the terminal silyl groups may have the formula such as —R^{a}Si(OR^{b})₂, —Si(OR^{b})₃, —R^{a}₂SiOR^{b} or —(R^{a})₂Si—R^{c}—SiR^{d}ₚ(OR^{b})₃₋ₚ where each R^{a} independently represents a monovalent hydrocarbyl group, for example, an alkyl group, in particular having from 1 to 8 carbon atoms, (and is preferably methyl); each Rb and Rd group is independently an alkyl group having up to 6 carbon atoms; R^{c} is a divalent hydrocarbon group which may be interrupted by one or more siloxane spacers having up to six silicon atoms; and p has the value 0, 1 or 2. Typically each terminal silyl group will have 2 or 3 alkoxy groups.

Component (b) thus includes alkyltrialkoxysilanes such as methyltrimethoxysilane (MTM) and methyltriethoxysilane, tetraethoxysilane, partially condensed tetraethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo) silane, vinyl-tris-methylethylketoximo) silane, methyltris(methylethylketoximino) silane, methyltris(isopropenoxy) silane, vinyltris(isopropenoxy) silane, ethylpolysilicate, n-propylorthosilicate, ethylorthosilicate, dimethyltetraacetoxydisiloxane, oximosilanes, acetoxy silanes, acetonoxime silanes, enoxy silanes and other such trifunctional alkoxysilanes as well as partial hydrolytic condensation products thereof; 1,6-bis(trimethoxysilyl) hexane (alternatively known as hexamethoxydisilylhexane. The component (b) used may also comprise any combination of two or more of the above. In one embodiment the cross-linker (b) comprises vinyl trimethoxysilane or methyl trimethoxysilane.

The one or more cross-linkers having at least 3 hydroxyl and/or hydrolysable groups per molecule (b) is/are present in an amount of from 0.05 parts to 10 parts by weight per to 100 parts by weight of component (a), alternatively from 0.1 to 7.5 parts by weight per to 100 parts by weight of component (a), alternatively from 0.5 to 6.0 parts by weight per to 100 parts by weight of component (a).

### Component (c) Catalyst

Condensation curable room temperature vulcanisable (RTV) silicone compositions as described herein utilise, as a catalyst, a cerium (IV) organometallic compound of the formula

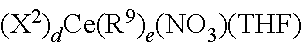

where X² is a bidentate ligand formed from any suitable 1,2-dicarbonyl compound, 1,3-dicarbonyl compound or 1,4-dicarbonyl compound;
THF is tetrahydrofuran;
R⁹ is an alkoxy group having from 1 to 10 carbons or a carboxylate group having from 1 to 20 carbons; and
d and e are one or two with the proviso that d+e=3; as further defined above. Typically, when utilised as a catalyst the cerium (IV) organometallic compounds are present in the composition in an amount of from 0.05 parts to 5 parts by weight per 100 parts by weight of component (a), alternatively of from 0.1 parts to 4 parts by weight per 100 parts by weight of component (a), alternatively of from 0.5 parts to 3 parts by weight per 100 parts by weight of component (a).

### Optional Ingredients

### One or More Reinforcing Fillers

The optional one or more reinforcing fillers may for example be selected from precipitated silica, fumed silica, precipitated calcium carbonate, or a mixture of two or more thereof. They are typically provided in the form of finely divided powders. Typically, the surface area of the reinforcing filler is at least 15 m²/g in the case of precipitated calcium carbonate measured in accordance with the BET method (ISO 9277:2010), alternatively 15 to 50 m²/g, alternatively 15 to 25 m²/g.

Silica reinforcing fillers have a typical surface area of at least 50 m²/g in accordance with the BET method (ISO 9277:2010). In the case of high surface area fumed silica and/or high surface area precipitated silica, these may have surface areas of from 75 to 400 m²/g measured in accordance with the BET method (ISO 9277:2010), alternatively of from 100 to 300 m²/g in accordance with the BET method (ISO 9277:2010).

The reinforcing fillers may be hydrophobically treated for example with one or more aliphatic acids, e.g., a fatty acid such as stearic acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other adhesive components. Specific examples organosilanes, organosiloxanes, or organosilazanes may include, but are not restricted to, silanol terminated trifluoropropylmethylsiloxane, silanol terminated vinyl methyl (ViMe) siloxane, silanol terminated methyl phenyl (MePh) siloxane, liquid hydroxyldimethyl-terminated polydiorganosiloxane containing an average from 2 to 20 repeating units of diorganosiloxane in each molecule, hydroxyldimethyl terminated phenylmethyl Siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and tetramethyldi(trifluoropropyl)disilazane; hydroxyldimethyl terminated polydimethylmethylvinyl siloxane, octamethyl cyclotetrasiloxane, and silanes including but not limited to methyltrimethoxysilane, dimethyldimethoxysilane, vinyltrimethoxysilane, methyltriethoxysilane, vinyltriethoxysilane, chlorotrimethyl silane, dichlorodimethyl silane, trichloromethyl silane. The surface treatment of the fillers makes them easily wetted by component (I). These surface modified fillers are preferably in a finely divided form and do not clump and can be homogeneously incorporated into the silicone polymer (I). This results in improved room temperature mechanical properties of the uncured compositions. The fillers may be pre-treated or may be treated in situ when being mixed with component (I). A small amount of water can be added together with the silica treating agent(s) as processing aid.

When present, depending on the filler(s) chosen the reinforcing fillers may be present in an amount of from 10 to 150 parts by weight per 100 parts by weight of component (a), alternatively from 10 to 120 parts by weight of reinforcing filler per hundred part by weight of component (a)), alternatively from 10 to 100 parts by weight of reinforcing filler per hundred part by weight of component (a). In the case when the selected fillers are precipitated silica and/or fumed silica or a combination thereof the inorganic fillers are present in a range of from about 10.0 to 50 parts by weight of reinforcing filler per hundred part by weight of component (a), alternatively 10 to 45 parts by weight of reinforcing filler per hundred part by weight of component (a), alternatively 10 to 40 parts by weight of reinforcing filler per hundred part by weight of component (a).

However, when reinforcing filler is precipitated calcium carbonate, the composition will tend to include a larger wt. % of the composition, e.g., from 30 to 150 parts by weight of reinforcing filler per hundred part by weight of component (a), alternatively of from 30 to 120 parts by weight of reinforcing filler per hundred part by weight of component (a), alternatively of from 40 to 120 parts by weight of reinforcing filler per hundred part by weight of component (a), alternatively of from 40 to 100 parts by weight of reinforcing filler per hundred part by weight of component (a). When the reinforcing filler is a mixture of silica and precipitated calcium carbonate the wt. % will typically somewhere therebetween.

Other optional ingredients may include non-reinforcing fillers, pigments, adhesion promotors, diluents (e.g., plasticisers and/or extenders), chain extenders, rheology modifiers, cure modifiers, UV stabilisers and fungicides and/or biocides and the like. These are often also incorporated into such compositions as and when required. Such silicone sealant compositions may be one-part compositions or multiple-part, e.g., two-part compositions. It will be appreciated that some of the additives may be included in more than one list of additives. Such additives would then have the ability to function in all the different ways referred to.

### Non-Reinforcing Fillers

Non-reinforcing fillers, which might be used alone or in addition to the above include aluminite, calcium sulphate (anhydrite), gypsum, nepheline, syenite, quartz, calcium sulphate, magnesium carbonate, clays such as kaolin, ground calcium carbonate, aluminium trihydroxide, magnesium hydroxide (brucite), graphite, copper carbonate, e.g., malachite, nickel carbonate, e.g., zarachite, barium carbonate, e.g., witherite and/or strontium carbonate e.g., strontianite.

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃·2SiO₂; kyanite; and Al₂SiO₅.

The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂Al₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite.

In addition, a surface treatment of the filler(s) may be performed, for example with a fatty acid or a fatty acid ester such as a stearate ester, stearic acid, salts of stearic acid, calcium stearate and carboxylatepolybutadiene. Treating agents based on silicon containing materials may include organosilanes, organosiloxanes, or organosilazanes hexaalkyl disilazane or short chain siloxane diols to render the filler(s) hydrophobic and therefore easier to handle and obtain a homogeneous mixture with the other sealant components. The surface treatment of the fillers makes the ground silicate minerals easily wetted by the silicone polymer. These surface modified fillers do not clump and can be homogeneously incorporated into the silicone polymer. This results in improved room temperature mechanical properties of the uncured compositions. Furthermore, the surface treated fillers give a lower conductivity than untreated or raw material.

The non-reinforcing filler(s) e.g., ground calcium carbonate, when present, can be present in any amount, as desired dependent on the end use of the composition up to about 150 parts by weight per 100 parts by weight of component (a). They are usually present in addition to reinforcing fillers, but this is not absolutely essential.

### Pigments and Colorants

Pigments and colorants are utilized to color the composition as required. Any suitable pigment or colorant may be utilized providing it is compatible with the composition.

### Rheology Modifiers

Rheology modifiers which may be incorporated in moisture curable compositions according to the invention include silicone organic co-polymers such as those described in EP0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion to substrates, particularly plastic substrates.

### Biocides

Biocides may additionally be utilized in the composition if required. It is intended that the term “biocides” includes bactericides, fungicides and algicides, and the like. Suitable examples of useful biocides, which may be utilized in compositions as described herein, include, for the sake of example:

Carbamates such as methyl-N-benzimidazol-2-ylcarbamate (carbendazim) and other suitable carbamates, 10,10′-oxybisphenoxarsine, 2-(4-thiazolyl)-benzimidazole, N-(fluorodichloromethylthio) phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyl) pentan-3-ol and/or 1-[[2-(2,4-dichlorophenyl)-4-propyl-1,3-dioxolan-2-yl]methyl]-1H-1,2,4-triazole. The fungicide and/or biocide may suitably be present in an amount of from 0 to 2.5 parts by weight per one hundred parts by weight of component (a) and may be present in an encapsulated form where required such as described in EP2106418.

Such additives may be present in any suitable amount with respect to the final use. Hence, when the cerium (IV) organometallic compounds described herein are utilised as condensation catalysts for a condensation curable room temperature vulcanisable (RTV) silicone composition, typically a one-part condensation curable room temperature vulcanisable (RTV) silicone composition component (a) may be any suitable organopolysiloxane polymer having at least two hydroxyl or hydrolysable groups per molecule; for example, component (a) may comprise:—
(a) an organopolysiloxane polymer having at least two hydroxyl or hydrolysable groups per molecule of the formula

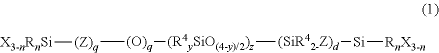

in which each X is independently a hydroxyl group or a hydrolysable group, each R is an alkyl, alkenyl or aryl group, each R⁴ is X group, alkyl group, alkenyl group or aryl group and Z is a divalent organic group;
d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 150,000 mPa·s at 25° C., alternatively from 40,000 to 140,000 mPa·s at 25° C. at 25° C.;

Component (b) is one or more cross-linkers in the form of a silicon containing compound having at least two, alternatively at least three hydrolysable groups per molecule in an amount of from in an amount of from 0.05 parts to 10 parts by weight per to 100 parts by weight of component (a), alternatively from 0.1 to 7.5 parts by weight per to 100 parts by weight of component (a), alternatively from 0.5 to 6.0 parts by weight per to 100 parts by weight of component (a); and Component (c) is one or more catalysts comprising the cerium (IV) organometallic compound having the structure a reaction product of a compound of the structure herein a cerium (IV) organometallic compound of the formula:

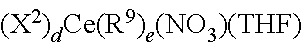

where X² is a bidentate ligand formed from any suitable 1,2-dicarbonyl compound, 1,3-dicarbonyl compound or 1,4-dicarbonyl compound (which act as chelating agents);
THF is tetrahydrofuran;
R⁹ is an alkoxy group having from 1 to 10 carbons or a carboxylate group having from 1 to 20 carbons; and
d and e are one or two with the proviso that d+e=3. Typically, when utilised as a catalyst the cerium (IV) organometallic compounds are present in the composition in an amount 0.05 parts to 5 parts by weight per 100 parts by weight of component (a), alternatively of from 0.1 parts to 4 parts by weight per 100 parts by weight of component (a), alternatively of from 0.5 parts to 3 parts by weight per 100 parts by weight of component (a).

The most commonly used optional additive will be one or more reinforcing fillers. When present, a reinforcing filler is present as one or more reinforcing fillers may for example be selected from precipitated silica, fumed silica, precipitated calcium carbonate, or a mixture of two or more thereof. They are typically provided in the form of finely divided powders. Typically, the surface area of the reinforcing filler is at least 15 m²/g in the case of precipitated calcium carbonate measured in accordance with the BET method (ISO 9277:2010), alternatively 15 to 50 m²/g, alternatively 15 to 25 m²/g. Silica reinforcing fillers have a typical surface area of at least 50 m²/g in accordance with the BET method (ISO 9277:2010). In the case of high surface area fumed silica and/or high surface area precipitated silica, these may have surface areas of from 75 to 400 m²/g measured in accordance with the BET method (ISO 9277:2010), alternatively of from 100 to 300 m²/g in accordance with the BET method (ISO 9277:2010).

When present, depending on the filler(s) chosen the reinforcing fillers may be present in an amount of from 10 to 150 parts by weight per 100 parts by weight of component (a), alternatively from 10 to 120 parts by weight of reinforcing filler per hundred part by weight of component (a)), alternatively from 10 to 100 parts by weight of reinforcing filler per hundred part by weight of component (a). When precipitated silica and/or fumed silica or a combination thereof are present, they are present in a range of from about 10.0 to 50 parts by weight of reinforcing filler per hundred part by weight of component (a), alternatively 10 to 45 parts by weight of reinforcing filler per hundred part by weight of component (a), alternatively 10 to 40 parts by weight of reinforcing filler per hundred part by weight of component (a).

However, when reinforcing filler is precipitated calcium carbonate, the composition will tend to include a larger amount of filler, e.g., from 30 to 150 parts by weight of reinforcing filler per hundred part by weight of component (a), alternatively of from 30 to 120 parts by weight of reinforcing filler per hundred part by weight of component (a), alternatively of from 40 to 120 parts by weight of reinforcing filler per hundred part by weight of component (a), alternatively of from 40 to 100 parts by weight of reinforcing filler per hundred part by weight of component (a). When the reinforcing filler is a mixture of silica and precipitated calcium carbonate the wt. % will typically somewhere therebetween.

The resulting compositions have a transparent to translucent appearance.

It will be appreciated that the composition herein is defined by parts by weight relative to 100 parts by weight of component (a) and therefore it is not measured in % values and the total amount of ingredients will always be greater than 100 parts by weight.

There is also provided herein a method of making the above condensation curable room temperature vulcanisable (RTV) silicone composition utilising the cerium (IV) organometallic compounds as catalyst, when it is a one-part condensation curable room temperature vulcanisable (RTV) silicone composition herein by mixing all the ingredients together. Preferably once mixed, unless to be used immediately, the composition is sealed in one or more moisture-tight containers and is stored at a temperature in a range of between 0° C. and 25° C. inclusive therein. In one embodiment, when reinforcing filler and/or non-reinforcing filler is present, said filler is first mixed into the polymer (a), optionally, if required in combination with a hydrophobic treating agent so that the filler is treated in situ during the mixing into the polymer. Once the filler is adequately mixed into the polymer (and if desired has been hydrophobically treated) then the remaining components are added to make the complete composition.

There is also provided herein an elastomeric sealant material which is the cured product of the one-part condensation curable room temperature vulcanisable (RTV) silicone composition as hereinbefore described.

In one embodiment a one-part condensation curable room temperature vulcanisable (RTV) silicone composition as described herein may be designed to provide a low modulus sealant composition. For the purpose of this invention, “low modulus” sealants are defined according to ISO11600, second edition 2002 Oct. 1, section 4.3. Low modulus silicone sealant compositions are preferably “gunnable” i.e., they have a suitable extrusion capability i.e., a minimum extrusion rate of 10 ml/min as measured by ASTM C1183-04, alternatively 10 to 1000 mL/min, and alternatively 30 to 500 mL/min.

When the composition herein is used in the form of a one-part condensation curable room temperature vulcanisable (RTV) silicone composition, it may case impart a movement capability to the post-cured sealant material. The movement capability is greater than 25%, alternatively movement capability ranges from 25% to 50%, as measured by ASTM C719-13.

Such a one-part condensation curable room temperature vulcanisable (RTV) silicone composition utilising the cerium (IV) based compound(s) as the condensation reaction catalyst as hereinbefore described may be a gunnable sealant composition used for
(i) space/gap filling applications;
(ii) seal applications, such as sealing the edge of a lap joint in a construction membrane; or
(iii) seal penetration applications, e.g., sealing a vent in a construction membrane;
(iv) adhering at least two substrates together; and/or
(v) a laminating layer between two substrates to produce a laminate of the first substrate, the sealant product and the second substrate.

In the case of (v) above when used as a layer in a laminate, the laminate structure produced is not limited to these three layers. Additional layers of cured sealant and substrate may be applied. The layer of gunnable sealant composition in the laminate may be continuous or discontinuous. A one-part condensation curable room temperature vulcanisable (RTV) silicone composition as hereinbefore described utilising the aforementioned cerium (IV) organometallic compounds as catalysts may be applied on to any suitable substrate. Suitable substrates may include, but are not limited to, glass; concrete; brick; stucco; metals, such as aluminium, copper, gold, nickel, silicon, silver, stainless steel alloys, and titanium; ceramic materials; plastics including engineered plastics such as epoxies, polycarbonates, poly(butylene terephthalate) resins, polyamide resins, polyvinyl chloride (PVC) and blends thereof, such as blends of polyamide resins with syndiotactic polystyrene commercially available from The Dow Chemical Company, of Midland, Michigan, U.S.A., acrylonitrile-butadiene-styrenes, styrene-modified poly(phenylene oxides), poly(phenylene sulfides), vinyl esters, polyphthalamides, and polyimides; cellulosic substrates such as paper, fabric, and wood; and combinations thereof. When more than one substrate is used, there is no requirement for the substrates to be made of the same material. For example, it is possible to form a laminate of plastic and metal substrates or wood and plastic substrates. After application and cure the elastomeric sealant product is non-staining (clean) with respect to porous substrates like granite, limestone, marble, masonry, metal and composite panels. Of particular note as proven in the following examples is the fact that this composition upon cure adheres to PVC substrates. In the case of the one-part condensation curable room temperature vulcanisable (RTV) silicone composition utilising the cerium (IV) organometallic compounds as catalysts, there is provided a method for filling a space between two substrates so as to create a seal therebetween, comprising:
a) providing a one-part condensation curable room temperature vulcanisable (RTV) silicone composition as hereinbefore described, and either
b) applying the one-part condensation curable room temperature vulcanisable (RTV) silicone composition to a first substrate, and bringing a second substrate in contact with the silicone composition that has been applied to the first substrate, or
c) filling a space formed by the arrangement of a first substrate and a second substrate with the one-part condensation curable room temperature vulcanisable (RTV) silicone composition and
d) curing same.

The one-part condensation curable room temperature vulcanisable (RTV) silicone composition as hereinbefore described utilising the cerium (IV) organometallic compounds as catalysts may therefore provide a silicone sealant which may be of a low-modulus type having high movement capabilities. Furthermore, the composition herein is clear, i.e., transparent and/or translucent and is non-staining (clean) on construction substrates which may or may not be porous, such as granite, limestone, marble, masonry, glass, metal and composite panels for use as a stain-resistant weather sealing sealant material for construction and the like applications.

Such compositions can be cured into silicone sealants which are used in a wide variety of applications, such as window and door assembly, caulking for kitchen and bathroom, outdoor weather-proof sealing of façade. The Low modulus nature of the silicone elastomer produced upon cure of the one-part condensation curable room temperature vulcanisable (RTV) silicone composition when designed to be low modulus described herein makes the elastomer effective at sealing joints which may be subjected to movement for any reason, because compared to other cured sealants (with standard or high modulus) lower forces are generated in the cured sealant body and transmitted by the sealant to the substrate/sealant interface due to expansion or contraction of the joint enabling the cured sealant to accommodate greater joint movement without failing cohesively or interfacially (adhesively) or cause substrate failure.

Hence, it will be appreciated that component (c) as described herein provides a very promising means of avoiding the potential issues observed with the use of standard titanate condensation cure catalysts which have been used for many years in one-part silicone sealant type compositions, i.e., discoloration, typically yellowing after sealant aging for a long time and adhesion failure which can happen due to Titanate degradation under UV.

Likewise, in respect to providing an alternative to tin catalysts due to the reversion, especially in confined spaces and the increasingly problematic issues around tin toxicity limiting the selection of tin catalysts which may still be utilised. The catalyst component (c) described herein is considered to be effective as a silicone RTV cure.

It was noted that the catalytic nature of the rare earth metal catalysts was much improved when suitably chelated particularly with acetylacetate compounds and was optionally and indeed was surprisingly particularly effective at accelerating the cure of compositions containing alkoxy terminated polymers when utilised as component (a). They unexpectedly effectively increased the cure speed of rare earth metal-based catalyst components (c), such that they can even be deemed to be comparable to the cure speed of tin-based catalysts.

### EXAMPLES

All viscosity measurements were taken at 25° C. unless otherwise indicated. Unless otherwise indicated, all viscosities in the examples were measured using a Modular Compact Rheometer (MCR) 302 rheometer from Anton Paar GmbH of Graz, Austria. Viscosities in the range of 30,000-160,000 mPa·s were measured using a 40 mm diameter cone-plate and a shear rate of 1 s⁻¹; viscosities in the range 2000-30,000 mPa·s were measured with a 50 mm diameter cone-plate and a shear rate of 1 s⁻¹; and viscosities in the range 10-2000 mPa·s were measured with a 75 mm diameter cone-plate and a shear rate of 1 s⁻¹. Solvents used for the preparation of the catalysts (e.g., THF) were refluxed and distilled using a solvent purification system (SPS) and dried over potassium metal overnight prior to use. All synthesis and manipulations of air- and moisture-sensitive materials were performed under dry argon and oxygen-free atmosphere using standard Schlenk techniques or in a glovebox.

### Catalyst Production for the Examples

Each cerium (IV) organometallic compound utilised in the examples or comparative examples as a condensation reaction catalyst was prepared using an analogous method. In the examples, the compounds prepared were where each R⁹ was a tertiary butoxy group and X² was trifluoroacetoacetate (TFEAA).

Synthetic Procedure for Ce(IV)-1: Ce(O^{t}Bu)₃(NO₃)(THF)₂.

In a preliminary step Ce(O^{t}Bu)₃(NO₃)(THF)₂ was prepared as follows:

10 mmol (5.482 g) of cerium (IV) ammonium nitrate sometimes referred to as CAN (Ce(NH₄)₂(NO₃)₆) and 50 ml of dried tetrahydrofuran (THF) were first introduced into a 100 ml round bottom. The resulting mixture was left to stir vigorously for 2 hours. Once a solution of the cerium (IV) ammonium nitrate in the THF was obtained, a 20 ml THF suspension of 40 mmol (4.488 g) of potassium tertiary butoxide (^{t}BuO⁻K⁺) was added to the solution of the cerium (IV) ammonium nitrate in THF, gradually over a 5-minute period. The resulting mixture was then left to stir for 12 hours. A yellow suspension was formed and filtered to give a brown/yellow solution. The brown/yellow solution was then dried under reduced pressure to form yellow solid of Ce(OtBu)₃(NO₃)(THF)₂. This was confirmed via X-ray diffraction for which a single crystal of the product was grown from a concentrated THE solution at −30° C. Yield: 3.735 g, 66%. This was used as a comparative unchelated cerium (IV) organometallic compound catalyst and as an intermediate for making the chelated cerium (IV) organometallic compounds as described herein.

Synthetic Procedure for the Production of Ce(IV)-2: (TFEAA)Ce(O^{t}Bu)₂(NO₃)(THF).

(TFEAA)Ce(O^{t}Bu)₂(NO₃)(THF) was prepared by introducing 1 mmol of Ce(O^{t}Bu)₃(NO₃)(THF)₂ and 2-3 ml of toluene into a 20 ml vial to form a clear solution (sometimes with little solid left). This solution was then sealed with a cap under argon and 1 molar equivalent of TFEAA (0.15 ml) (1.259 g/ml MW: 184.11) was then added to the solution whilst maintaining the argon atmosphere using a syringe while swirling. It was observed that the colour of the solution changed from brown/yellow to dark red immediately upon addition and it was believed that the resultant product was mainly (TFEAA)Ce(O^{t}Bu)₂(NO₃)(THF), ¹H NMR: 400 MHz, C₆D₆, δ=3.81 ppm (m, 8H, 2 THF), 1.34 ppm (m, 8H, 2 THF), 1.27 ppm (s, 27H, tBu).

Synthetic Procedure for the Production of Ce(IV)-3: (TFEAA)₂Ce(O^{t}Bu)(NO₃)(THF).

(TFEAA)₂Ce(O^{t}Bu)(NO₃)(THF) was prepared by introducing 1 mmol of Ce(O^{t}Bu)₃(NO₃)(THF)₂ and 2-3 ml of toluene into a 20 ml vial to form a clear solution (sometimes with little solid left). This solution was then sealed with a cap under argon and 1 molar equivalent of TFEAA (0.15 ml) (1.259 g/ml MW: 184.11) was then added to the solution whilst maintaining the argon atmosphere using a syringe while swirling. It was observed that the colour of the solution changed from brown/yellow to dark red immediately upon addition and it was believed that the resultant product was mainly (TFEAA)₂Ce(O^{t}Bu)(NO₃)(THF). The Ce(IV)-1 (unchelated) and Ce(IV)-2 (chelated) compounds prepared above were then assessed for their suitability as condensation reaction catalysts in a series of examples depicted in Table 1 for curing a basic silicone polymer and cross-linker combination.

The following ingredients were used in the compositions depicted in Table 1:
Polymer 1: Hydroxyl terminated polydimethylsiloxane, viscosity 2500 mPa·s at 25° C.;
Polymer 2: a Trimethoxysilyl terminated polydimethylsiloxane, viscosity 11000 mPa·s at 25° C.;
MTM: methyl trimethoxysilane;
Ce(IV)-1: Ce(O^{t}Bu)₃(NO₃)(THF)₂ and
Ce(IV)-2: was interpreted to be mainly (TFEAA)Ce(O^{t}Bu)₂(NO₃)(THF).

TABLE 1
Assessment as to suitability of Ce(IV)-1 and
Ce(IV)-2 compounds as condensation catalysts

| | Comp. 1 | Ex. 1 | Comp. 2 | Ex. 2 |
|---|---|---|---|---|
| Polymer 1 (g) | 10 | 10 | | |
| Polymer 2 (g) | | | 10 | 10 |
| MTM (g) | 0.4 | 0.4 | 0.3 | 0.3 |
| Catalyst type | Ce(IV)-1 | Ce(IV)-2 | Ce(IV)-1 | Ce(IV)-2 |
| Catalyst amount (mmol) | 0.25 | 0.25 | 0.25 | 0.25 |
| Properties | | | | |
| Tack free time (TFT) (min) | 9 | 4 | >1080 | 67 |
| Comments | not gel | not gel | | |

The tack free time was measured using a polyethylene film in accordance with CTM0095, the corporate test method for measuring skin over time (SOT) and tack free time (TFT), available to the public upon request from Dow Silicones Corporation of Midland Michigan, USA.

It can be seen that inclusion of a bidentate ligand in Ce(IV)-2 compounds dramatically reduced the tack free time for the different compositions indicating a significant increase in catalytic functionality in the presence of the bidentate ligand in the compound. In the case of using OH terminated polymer 1, whilst Ce(IV)-1 (unchelated)Ce(O^{t}Bu)₃(NO₃)(THF)₂ catalysed cure without unwanted gelling the tack free time (TFT) when using same was double that when using Ce(IV)-2 (chelated) compounds as the catalyst. When using Ce(IV)-1 compounds to cure an alkoxy terminated siloxane polymer, Ce(IV)-1 (unchelated) took an unacceptably longer period of time for TFT to be achieved, especially when compared to using Ce(IV)-2 (chelated) compounds as the catalyst.

An analogous series of examples were then undertaken using two standard calcium carbonate filled compositions as defined in Table 2 below:

TABLE 2
Composition of standard uncatalyzed calcium carbonate
filed compositions used in Examples below (wt. %):

| Material | Formulation 1 (%) | Formulation 2 (%) |
|---|---|---|
| Polymer 3 | 30.02 | 30.33 |
| Plasticiser | 10.57 | 10.68 |
| Ground Calcium Carbonate | 24.87 | 25.12 |
| Ppt Calcium carbonate | 31.52 | 31.84 |
| MTM | 3.02 | 2.03 |
| Total | 100 | 100 |

### In the Above Compositions

Polymer 3: Polydimethylsiloxane hydroxy-terminated, viscosity 50,000 mPa·s at 25° C.;
Plasticiser: trimethyl terminated polydimethylsiloxane having a viscosity of about 100 mPa·s at 25° C.;
Ground calcium carbonate: a stearate treated ground calcium carbonate;
Ppt Calcium carbonate: a stearate treated precipitated calcium carbonate; The above formulations 1 and 2 were prepared in the same manner. Firstly, the ground calcium carbonate and precipitated calcium carbonate were dried in an oven set at 105° C. for two hours. The polymer and about 40% of the plasticiser were mixed together under vacuum before the calcium carbonate fillers were introduced under nitrogen. The polymer, plasticiser and fillers were then mixed together for a period of about 20 minutes. Subsequently the remaining plasticiser and then the MTM cross-linker was added. The resulting product was then stored in cartridges prior to use. Unchelated Ce(IV)-1 and chelated Ce(IV)-2 were further assessed for their catalytic nature using calcium carbonate filled compositions in accordance with formulation 1 of Table 2. In each case 1.35 mmol of the respective catalyst was introduced into the formulation 1 and the cure was tracked by determining the tack free time. The results are shown in Table 3 below.

TABLE 3
Examples in chalk filled total formulation:

| | Comp. 3 | Ex. 3 |
|---|---|---|
| Formulation 1 (g) | 100 | 100 |
| Catalyst type | Ce(IV)-1 | Ce(IV)-2 |
| Catalyst amount (mmol) | 1.35 | 1.35 |
| Properties | | |
| TFT (min) | Between | 80 |
| | 540 and 4320 | |

Formulation 1 intermixed with unchelated Ce(IV)-1 (i.e., without TFEAA chelated ligand) arrived at a tack free cure very slowly, whereas formulation 1 when mixed with Ce(IV)-2 (containing TFEAA chelated ligand) cured at a rate showed suitable cure speed and good appearance without gelation. Filler free compositions were then compared with identical compositions using standard commercial titanium catalysts TYZOR™ PITA which is a diisopropoxy diethylacetoacetato Titanium (IV) compound and Tetra-tert-butyl orthotitanate (TtBT) both from Dorf Ketal Specialty Catalysts LLC. Compositions utilising polymer 1 are compared in Table 4a and compositions utilising polymer 2 are compared in Table 4b below.

TABLE 4a
Examples in OH PDMS polymer model formulation:

| | Ex. 4A | Ex. 5A | Comp. 4A | Comp. 5A |
|---|---|---|---|---|
| Polymer 1 (g) | 10 | 10 | 10 | 10 |
| MTM (g) | 0.4 | 0.4 | 0.4 | 0.4 |
| Catalyst type | Ce(IV)-2 | Ce(IV)-3 | TYZOR ™ PITA | TtBT |
| Catalyst amount (mmol) | 0.25 | 0.25 | | |
| [Ti] (mmol) | | | 0.25 | 0.25 |
| Properties | | | | |
| TFT (min) | 5 | 3 | 12 | <1 |
| Appearance | Good | good | good | gel |

In the above Ce(IV)-3 was interpreted to be mainly (TFEAA)₂Ce(O^{t}Bu)(NO₃)(THF).

TABLE 4b
Examples in polymer 2 compositions:

| | Example 4B | Example 5B | Comp. 4B | Comp. 5B |
|---|---|---|---|---|
| Polymer 2 (g) | 6.00 | 6.00 | 6.00 | 6.00 |
| MTM (g) | 0.18 | 0.18 | 0.18 | 0.18 |
| Catalyst type | Ce(IV)-2 | Ce(IV)-3 | TYZOR ™ PITA | TtBT |
| Catalyst amount (mmol) | 0.15 | 0.15 | 0.15 | 0.15 |
| Properties | | | | |
| TFT (min) | 25 | 14 | 36 | 112 |

In our view the TFT results shown in both Tables 4a and 4b showed good cure in both polymer 1 (OH polymer) and polymer 2 (alkoxy terminated polymer) compositions. They have comparable or even better curing performance than the benchmark titanates at the same molar loading level. Subsequently calcium carbonate filled composition comprising Ce(IV)-3 (Ex. 6) was compared with TYZOR™ PITA (Comp. 6) with the physical property results for Ex. 6 results provided in Table 5. The tack free time for Comp. 6 was deemed too long to merit taking the results.

TABLE 5
Examples in chalk filled total formulation.

| | Example 6 | Comp. 6 |
|---|---|---|
| Formulation 2 (g) | 100 | 100 |
| Catalyst type | Ce(IV)-3 | TYZOR ™ PITA |
| Catalyst amount (mmol) | 1.37 | 1.37 |
| Properties | | |
| TFT @ Room Temp. (CTM0095, min) | 22 | 90 |
| TFT @ 38° C. & 95% RH (CTM0095, min) | 20 | >300 |
| TFT 50° C. (CTM0095, min) | 9 | 22 |
| Tensile Strength (ASTM D412-98a, MPa) | 1.28 | |
| Elongation at break (ASTM D412-98a, %) | 485 | |
| Modulus at 100% elongation (ASTM D412-98a, MPa) | 0.48 | |
| Durometer (ASTM D2240-97, Shore A) | 27.6 | |

In the above RH stands for relative humidity.

Ex. 6 showed improved surface curing under high temperature (greater than room temperature) high humidity environments. However, comp. 6 utilising TYZOR™ PITA showed much slower cure under high temperature high humidity environment. The mechanical properties of Ex. 6, with Ce(IV)-3, were also tested, showing good mechanical strength of the sealant cured therewith.

What is claimed is:

1. A cerium (IV) organometallic compound of the formula: 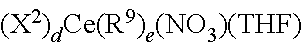
where X² is a bidentate ligand formed from any suitable 1,2-dicarbonyl compound, 1,3-dicarbonyl compound or 1,4-dicarbonyl compound;
THF is tetrahydrofuran;
R⁹ is an alkoxy group having from 1 to 10 carbons or a carboxylate group having from 1 to 20 carbons; and
d and e are one or two with the proviso that d+e=3.

2. A The cerium (IV) organometallic compound in accordance with claim 1 wherein X² is selected from
1,1,1-Trifluoro-2,4-pentanedione, 2,4-pentanedione); 2,4-hexanedione; 2,4-heptanedione; 3,5-heptanedione: 3-ethyl-2,4-pentanedione; 5-methyl-2,4-hexanedione; 2,4-octanedione; 3,5-octanedione; 5,5-dim-ethyl-2,4-hexanedione; 6-methyl-2,4-heptanedione; 2,2-dimethyl-3,5-nonanedione; 2,6-dimethyl-3,5-heptanedione; 2-acetylcyclohexanone; 2,2,6,6-tetramethyl-3,5-heptanedione (t-Bu-acac); 1,1,1,5,5,5-hexafluoro-2,4-pen-tanedione (F-acac)]; benzoylacetone; dibenzoylmethane; 3-methyl-2,4-pentadione; 3-acetyl-2-pentanone; 3-acetyl-2-hexanone; 3-acetyl-2-heptanone; 3-acetyl-5-methyl-2-hexanone; stearoyl benzoyl methane; octanoyl benzoyl methane; 4-t-butyl-4′-methoxydibenzoylmethane; 4,4′-dimethoxy-dibenzoylmethane and 4,4′-di-tart-butyldibenzoylmethane, methyl pivaloylacetate, Ethyl 4,4,4-trifluoroacetoacetate or 1,1,1-Trifluoro-2,4-pentanedione.

3. The cerium (IV) organometallic compound in accordance with claim 1 wherein X² is selected from methyl pivaloyl acetate, Ethyl 4,4,4-trifluoroacetoacetate or 1,1,1-Trifluoro-2,4-pentanedione.

4. The cerium (IV) organometallic compound in accordance claim 1, wherein R⁹ is an alkoxy group selected from methoxy, ethoxy, propoxy, isopropoxy, n-butoxy, tertiary butoxy, pentoxy, tertiary pentoxy or hexoxy or 2,4-dimethyl-3-pentoxy and/or a primary, secondary or tertiary carboxylate group which may be linear or branched selected from a propanoate group, an acetate group, a butanoate group, a 2-methyl propanoate group, a benzoate group, a 2-ethylhexanoate group, a stearate group, a 2-ethylbutanoate group or a naphthenate group.

5. The cerium (IV) organometallic compound in accordance claim 1, wherein R⁹ is an alkoxy group having from 1 to 6 carbons.

6. A method of making a cerium (IV) organometallic compound in accordance with claim 1 by
(i) dissolving an amount of Ce(R⁹)₃(NO₃)(THF)₂ in toluene to form a clear solution, optionally a saturated solution with a little solid left in the mixture to form a step (i) product;
(ii) sealing the product of step (i) in a chemically unreactive atmosphere; and
(iii) Introducing one or two molar equivalents of the bidentate ligand relative to the Ce(R⁹)₃(NO₃)(THF)₂ while agitating to form the cerium (IV) organometallic compound.

7-9. (canceled)

10. A condensation curable room temperature vulcanisable (RTV) silicone composition comprising:
(a) an organopolysiloxane polymer having at least two hydroxyl or hydrolysable groups per molecule;
(b) one or more cross-linkers in the form of a silicon containing compound having at least two, alternatively at least three hydrolysable groups per molecule; and
(c) one or more catalysts comprising the cerium (IV) organometallic compound in accordance with claim 1.

11. The condensation curable room temperature vulcanisable (RTV) silicone composition in accordance with claim 10 wherein component (a) comprises
(a) an organopolysiloxane polymer having at least two hydroxyl or hydrolysable groups per molecule of the formula 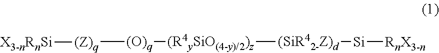
in which each X is independently a hydroxyl group or a hydrolysable group, each R is an alkyl, alkenyl or aryl group, each R⁴ is an X group, alkyl group, alkenyl group or aryl group and Z is a linear or branched alkylene group having from 1 to 12 carbon atoms which may be interrupted by one or more linear or branched siloxane groups comprising from 1 to 20 silicon atoms;
d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 150,000 mPa·s at 25° C., alternatively from 40,000 to 140,000 mPa·s at 25° C.

12. The condensation curable room temperature vulcanisable (RTV) silicone composition in accordance with claim 10 additionally comprising one or more reinforcing fillers selected from fumed silica, precipitated silica, precipitated calcium carbonate or a mixture thereof.

13. The condensation curable room temperature vulcanisable (RTV) silicone composition in accordance with claim 10, additionally comprising one or more additional additives selected from non-reinforcing fillers, pigments, adhesion promotors, plasticisers and/or extenders, chain extenders, rheology modifiers, cure modifiers, UV stabilisers, fungicides and/or biocides and the like.

14. (canceled)

15. A method for filling a space between two substrates so as to create a seal therebetween, comprising:
a) providing a silicone composition in accordance with claim 10, and either
b) applying the silicone composition to a first substrate, and bringing a second substrate in contact with the silicone composition that has been applied to the first substrate, or
c) filling a space formed by the arrangement of a first substrate and a second substrate with the silicone composition and
d) curing the silicone composition.
